(19) United States
(12) Patent Application Publication
(10) Pub. No.: US 2025/0183405 A1
(43) Pub. Date: Jun. 5, 2025

(54) INTEGRATED BATTERY COOLING CHANNELS AS FIREFIGHTING AGENT DELIVERY SYSTEM

(71) Applicant: Tyco Fire Products LP, Cranston, RI (US)

(72) Inventors: Sean S. Troutt, Stephenson, MI (US); David Strobel, Marinette, WI (US)

(73) Assignee: Tyco Fire Products LP, Cranston, RI (US)

(21) Appl. No.: 18/840,606

(22) PCT Filed: Mar. 23, 2023
(86) PCT No.: PCT/IB2023/052879

§ 371 Date: Aug. 22, 2024

Related U.S. Application Data
(60) Provisional application No. 63/323,602, filed on Mar. 25, 2022.

(51) Int. Cl. H01M 10/6556; H01M 10/42; H01M 10/613; H01M 10/625

(52) U.S. Cl. CPC H01M 10/6556; H01M 10/425; H01M 10/613; H01M 10/625; H01M 2010/4271; H01M 2220/20

(57) ABSTRACT

A battery system includes a housing defining a volume, and a battery module arranged within the housing, where the battery module includes a plurality of battery cells configured to provide an electrical output. The battery system also includes a cooling system having a cooling channel, the cooling channel configured to pass within the battery module and is arranged adjacent the plurality of battery cells, where the cooling channel is configured to facilitate temperature control of the battery module. The battery system also includes a suppression system having a suppressant, where the suppression system is configured to provide the suppressant to the battery module to mitigate a thermal runaway event.

### CROSS-REFERENCE TO RELATED PATENT APPLICATION

This application claims the benefit of and priority to U.S. Provisional Application No. 63/323,602, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, and tightly packed together making it difficult for an external source of fire suppressant to reach the cells.

### SUMMARY

At least one embodiment relates to a battery system. The battery system includes a housing defining a volume, and a battery module arranged within the housing, where the battery module includes a plurality of battery cells configured to provide an electrical output. The battery system also includes a cooling system having a cooling channel, the cooling channel configured to pass within the battery module and is arranged adjacent the plurality of battery cells, where the cooling channel is configured to facilitate temperature control of the battery module. The battery system also includes a suppression system having a suppressant, where the suppression system is configured to provide the suppressant to the battery module to mitigate a thermal runaway event.

In some embodiments, the suppression system includes a distribution network coupled to one or more passages of the cooling channel, where in response to a failure at the battery module the suppression system is configured to provide the suppressant to the one or more passages.

In some embodiments, the one or more passages are configured to facilitate movement of the suppressant to a target area adjacent to a rupture of the one or more passages.

In some embodiments, the suppression system is configured to provide the suppressant to the one or more passages at a pressure, where the pressure of the suppressant in the one or more passages is such that the one or more passages is configured to rupture at a target area and deliver the suppressant to the target area.

In some embodiments, the failure at the battery module includes a change in operating temperature of a battery cell positioned adjacent to the one or more passages above a threshold, where the change in operating temperature of the battery cell above the threshold is such that the one or more passages is configured to rupture at a target area and deliver the suppressant to the target area.

In some embodiments, the cooling channel includes a suppressant membrane coupled to an exterior of the cooling channel, the suppressant membrane configured to selectively seal an aperture of the one or more passages of the cooling channel.

In some embodiments, the failure at the battery module includes a change in operating temperature of a battery cell positioned adjacent to the one or more passages above a threshold, and the failure at the battery module causes the suppressant membrane to unseal the aperture of the one or more passages and facilitate delivery of the suppressant to a target area.

In some embodiments, the distribution network is coupled with a first passage of the one or more passages of the cooling channel and a second passage of the one or more passages of the cooling channel, where the first passage is configured to receive a coolant to facilitate temperature control of the battery system and the second passage is configured to facilitate movement of the suppressant to a target area in response to the failure at the battery module.

In some embodiments, the cooling system further comprises another cooling channel, the other cooling channel configured to pass along an exterior of the battery module, where the distribution network is coupled to the one or more passages of the other cooling channel, and where in response to the failure at the battery module the suppression system is configured to provide the suppressant to the one or more passages of the other cooling channel.

Another embodiment relates to a vehicle comprising a chassis, a plurality of tractive elements coupled with the chassis, and a prime mover coupled with the plurality of tractive elements, the prime mover configured to drive the plurality of tractive elements to propel the vehicle. The vehicle also includes a battery system coupled with the chassis, the battery system comprising a housing defining a volume, and a battery module arranged within the housing, where the battery module comprises a plurality of battery cells configured to provide an electrical output. The battery system also includes a cooling system having a cooling channel, the cooling channel configured to pass within the battery module and arranged adjacent the plurality of battery cells, where the cooling channel is configured to facilitate temperature control of the battery module. The battery system further includes a suppression system having a suppressant, where the suppression system is configured to provide the suppressant to the battery module to mitigate a thermal runaway event.

In some embodiments, the suppression system includes a distribution network coupled to one or more passages of the cooling channel, where in response to a failure at the battery module the suppression system is configured to provide the suppressant to the one or more passages.

In some embodiments, the one or more passages are configured to facilitate movement of the suppressant to a target area adjacent to a rupture of the one or more passages.

In some embodiments, the suppression system is configured to provide the suppressant to the one or more passages at a pressure, where the pressure of the suppressant in the one or more passages is such that the one or more passages is configured to rupture at a target area and deliver the suppressant to the target area.

In some embodiments, the failure at the battery module includes a change in operating temperature of a battery cell positioned adjacent to the one or more passages above a threshold, where the change in operating temperature of the battery cell above the threshold is such that the one or more passages is configured to rupture at a target area and deliver the suppressant to the target area.

In some embodiments, the cooling channel includes a suppressant membrane coupled to an exterior of the cooling channel, the suppressant membrane configured to selectively seal an aperture of the one or more passages of the cooling channel.

In some embodiments, the failure at the battery module includes a change in operating temperature of a battery cell positioned adjacent to the one or more passages above a threshold, and the failure at the battery module causes the suppressant membrane to unseal the aperture of the one or more passages and facilitate delivery of the suppressant to a target area.

Another embodiment relates to a battery pack including a housing defining a volume, and a battery module arranged within the housing, where the battery module comprises a plurality of battery cells configured to provide an electrical output. The battery pack further includes a cooling channel configured to pass within the battery module and arranged adjacent the plurality of battery cells, where the cooling channel is configured to facilitate temperature control of the battery module, and a distribution network coupled to one or more passages of the cooling channel, the distribution network is configured to receive a suppressant to mitigate a thermal runaway event.

In some embodiments, in response to a failure at the battery module, the one or more passages are configured to facilitate movement of the suppressant to a target area adjacent to a rupture of the one or more passages.

In some embodiments, the one or more passages are configured receive the suppressant at a pressure, where the pressure of the suppressant in the one or more passages is such that the one or more passages is configured to rupture at a target area and deliver the suppressant to the target area.

In some embodiments, the cooling channel includes a suppressant membrane coupled to an exterior of the cooling channel, the suppressant membrane configured to selectively seal an aperture of the one or more passages of the cooling channel.

Another embodiment relates to a batter pack. The battery pack includes a housing defining a volume, and a subpack arranged within the housing, the subpack comprising a battery module having a plurality of battery cells configured to provide an electrical output. The battery pack also including a cooling channel configured to pass within the subpack and arranged adjacent the battery module, where the cooling channel is configured to facilitate temperature control of the battery module. The battery pack also including a distribution network coupled to one or more passages of the cooling channel, where the distribution network is configured to receive a suppressant to mitigate a thermal runaway event.

In some embodiments, in response to a failure at the battery module, the one or more passages are configured to facilitate movement of the suppressant to a target area adjacent to a rupture of the one or more passages.

In some embodiments, the one or more passages are configured receive the suppressant at a pressure, and where the pressure of the suppressant in the one or more passages is such that the one or more passages is configured to rupture at a target area and deliver the suppressant to the target area.

In some embodiments, the target area is at the battery module, and wherein the suppressant is configured to fill an interior portion of the subpack.

Another embodiment relates to a battery pack. The battery pack includes a housing defining a volume, and a plurality of subpacks arranged within the housing, each of the plurality of subpacks comprising a battery module having a plurality of battery cells configured to provide an electrical output. The battery pack including a cooling channel configured to pass within the housing and arranged adjacent at least one subpack of the plurality of subpacks, where the cooling channel is configured to facilitate temperature control of the housing. The battery pack also including a distribution network coupled to one or more passages of the cooling channel, where the distribution network is configured to receive a suppressant to mitigate a thermal runaway event.

In some embodiments, in response to a failure at the at least one subpack, the one or more passages are configured to facilitate movement of the suppressant to a target area adjacent to a rupture of the one or more passages.

In some embodiments, the one or more passages are configured receive the suppressant at a pressure, and wherein the pressure of the suppressant in the one or more passages is such that the one or more passages is configured to rupture at a target area and deliver the suppressant to the target area.

In some embodiments, the target area is at the at least one subpack, and wherein the suppressant is configured to fill a portion of the volume of the housing.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a schematic diagram of the battery system of FIG. 1, according to another exemplary embodiment.

FIG. 6 is an end view of a cooling channel of the battery system of FIG. 1, according to an exemplary embodiment.

FIG. 7 is an end view of a cooling channel and a suppression system of the battery system of FIG. 1, according to an exemplary embodiment.

FIG. 8 is an end view of a cooling channel and a suppression system of the battery system of FIG. 1, according to another exemplary embodiment.

FIG. 9 is an end view of a cooling channel and a suppressant membrane of the battery system of FIG. 1, according to another exemplary embodiment.

FIG. 10 is a top view of a cooling channel and a distribution network within a battery module of the battery system of FIG. 1, according to an exemplary embodiment.

FIG. 11 is a top view of a cooling channel and a distribution network within a battery module of the battery system of FIG. 1, according to another exemplary embodiment.

FIG. 12 is a side view of a cooling channel and a distribution network within a battery module of the battery system of FIG. 1, according to another exemplary embodiment.

FIG. 13 is a top view of a cooling channel and a distribution network within a battery module of the battery system of FIG. 1, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a battery system configured to provide a fire suppressant or agent to components of a battery pack in order to prevent, eliminate, and/or mitigate a failure or thermal runaway event is shown, according to an exemplary embodiment. In an exemplary embodiment, the battery system includes a battery module having a plurality of battery cells configured to provide an electrical output. The battery system may also include a cooling system having a cooling channel, the cooling channel configured to pass within the battery module adjacent to the plurality of battery cells, and facilitate temperature control of the battery pack. The battery system may also include a suppression system having a suppressant; the suppression system may be configured to provide the suppressant to the battery system to mitigate thermal runaway and/or fire. According to an exemplary embodiment, the suppression system is coupled to the cooling channel, and in response to a failure of the battery system, the suppression system is configured to provide the suppressant to the cooling channel so as to prevent, eliminate, and/or mitigate a runaway event and/or fire. In this regard, the battery system described herein may integrate a suppression system with existing components of a battery pack (e.g., a cooling channel), so as to utilize existing conduits of the battery pack for targeted delivery of a suppressant.

In an exemplary embodiment, the battery system described herein is configured to utilize integrated active cooling channels in battery packs as part of a suppression system for firefighting agents. Given that battery packs have limited free space, the battery system described herein may utilize existing components (e.g., channels, conduits, etc.) as conduits for targeted delivery of a suppressant and/or agent, so as to eliminate the additional component parts (e.g., piping, etc.). In an exemplary embodiment, the suppression system takes over when the cooling system or components thereof (e.g., a cooling channel, cooling passageways, etc.) is/are overwhelmed or fail. In this regard, the cooling passages of the cooling channel may be intentionally ruptured by over pressurization from the suppression system during delivery of a suppressant and/or agent, so as to provide targeted delivery of the suppressant and/or agent to the rupture. In some embodiments, the cooling passages of the cooling channel are ruptured due to a localized hazard event (e.g., a failure or thermal runaway event). In this regard, the suppression system may deliver the suppressant and/or agent to a target area at the ruptures, via the passages. In other embodiments, one or more cooling passages of the cooling channel are dedicated suppressant passages, which may be partially perforated (e.g., include one or more apertures along the length of the passages). In this regard, the suppression system may deliver a suppressant and/or agent to a localized target area, or uniformly to a battery module, via the dedicated suppressant passages.

### System Overview

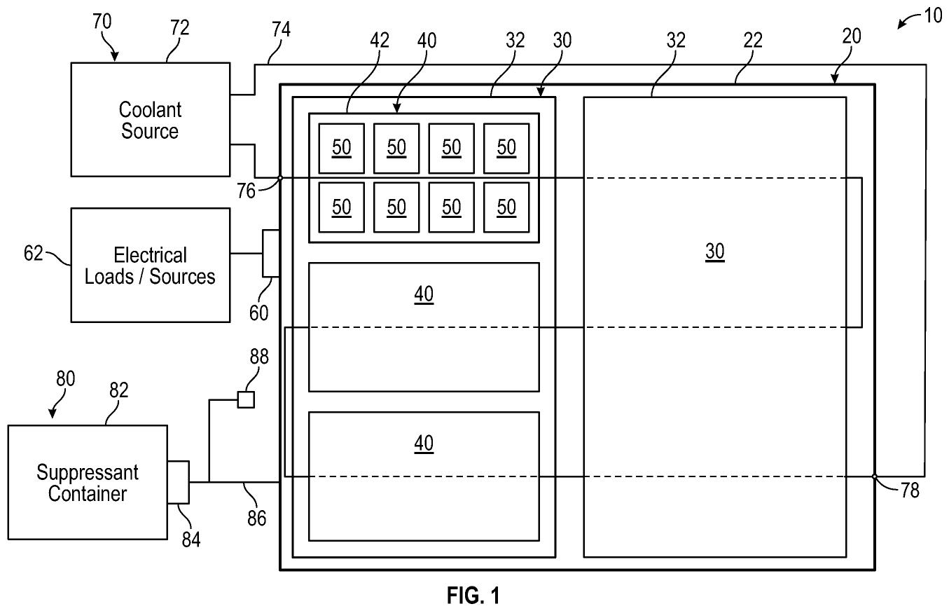

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40)

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88 that is positioned to direct suppressant to the exterior of the pack housing 22.

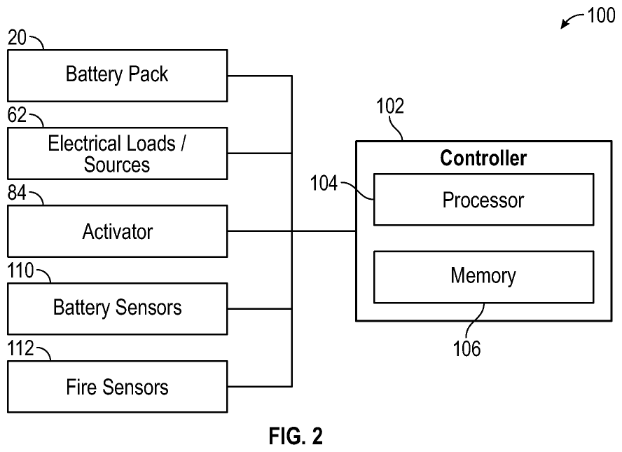

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

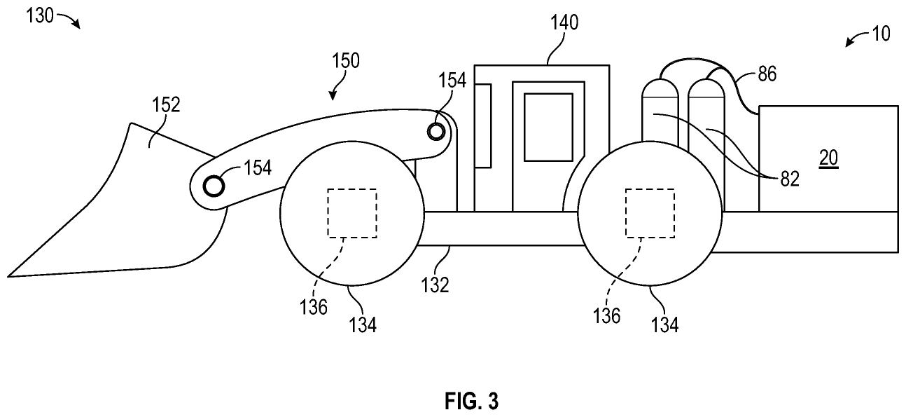

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

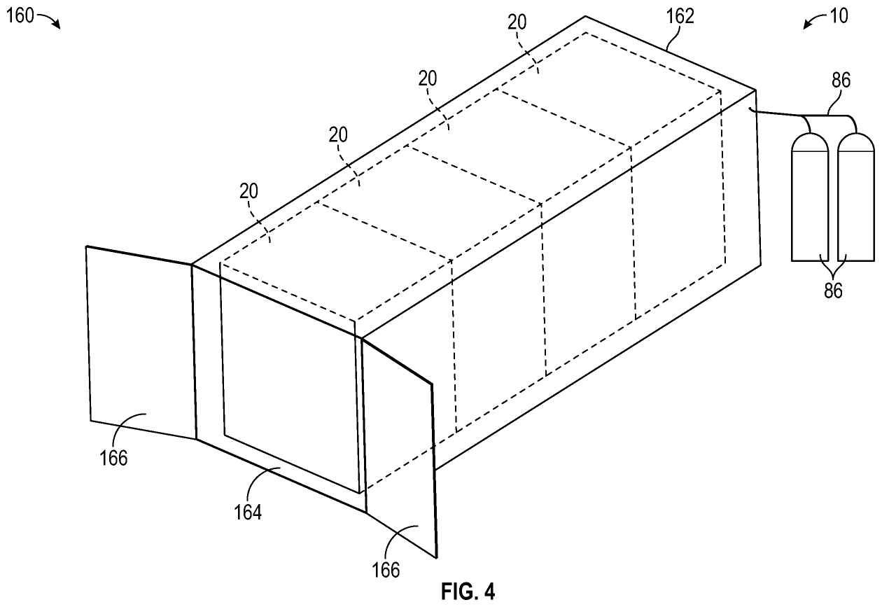

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Integrated Cooling Channel for Agent Delivery

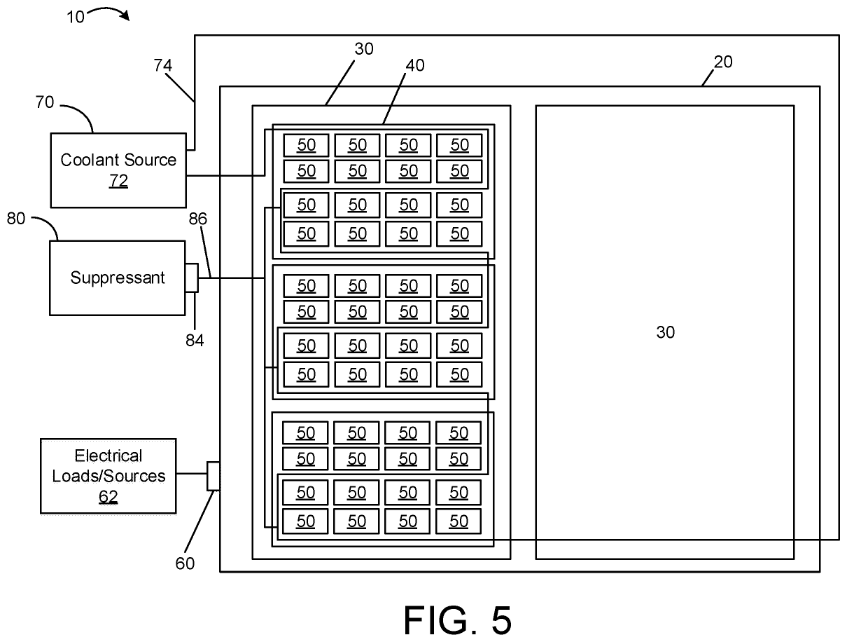

Referring now to FIG. 5, a power system or battery system is shown, according to an exemplary embodiment. In an exemplary embodiment, the power system or battery system is the system 10 of FIG. 1. The system 10 is shown to include the battery pack 20 having the subpacks 30, battery modules 40, and battery cells 50. According to an exemplary embodiment, the system 10 also includes the cooling system 70, the suppression system 80, and the electrical port 60 to power the electrical loads/sources 62 (e.g., via components of the battery pack 20). The system 10 may also be used in combination with the control system 100 of FIG. 2, the vehicle 130 of FIG. 3, and/or the container system 160 of FIG. 4. According to an exemplary embodiment, the suppression system 80 is coupled to the cooling system 70, such that the suppression system 80 is configured to utilize a cooling channel of the cooling system 70 to provide a fire suppressant or agent to components of the battery pack 20 in order to prevent, eliminate, and/or mitigate a failure or a thermal runaway event.

As shown in FIG. 5, the battery pack 20 includes the subpacks 30, which include the battery modules 40 and the battery cells 50. The subpacks 30 may include any suitable number of battery modules 40 (e.g., 3, 5, 10, 15, etc.), and the battery modules 40 may include any suitable number of battery cells 50 (e.g., 10, 50, 100, 250, etc.). According to an exemplary embodiment, the battery cells 50 are arranged in rows adjacent to one another within the battery module 40, thereby reducing empty space within the battery module 40 and the overall size of the battery pack 20. The battery cells 50 may be arranged in any suitable number of rows (e.g., 5, 10, 25, 50, etc.), and/or may be any suitable cells (e.g., cylindrical cells, prismatic cells, pouch cells, etc.) configured to receive, store, and/or release electrical energy.

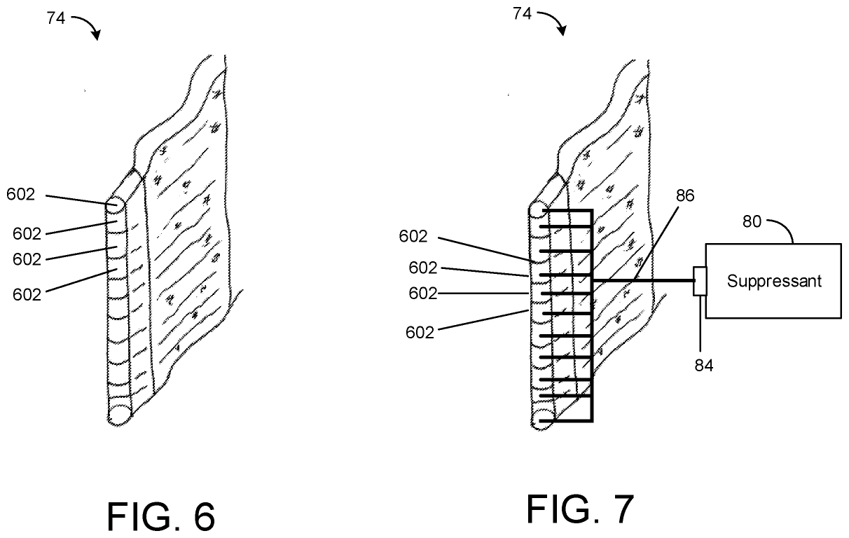

As shown in FIG. 5, the cooling system 70 includes the coolant source 72 and the cooling channel 74, according to an exemplary embodiment. In an exemplary embodiment, the cooling system 70 (e.g., via the cooling channel 74) is configured to supply a coolant to components of the battery pack 20, such that thermal energy generated by the battery pack 20 may be transferred to the coolant and/or discharged from the battery pack 20. As shown in FIG. 5, the cooling channel 74 may pass through the battery pack 20, the subpacks 30, and the battery modules 40, and may be arranged adjacent to (e.g., proximate to, coupled to, in contact with, etc.) the battery cells 50. In an exemplary embodiment, the cooling channel 74 is substantially flat and arranged between one or more rows of the battery cells 50, such that the cooling channel 74 snakes between rows of the battery cells 50 within the battery module 40. The cooling channel 74 may include one or more passageways (shown in FIGS. 6-9), which may be configured to transfer a coolant and/or a suppressant to one or more components of the battery pack 20, so as to prevent, eliminate, and/or mitigate a failure or a thermal runaway event.

As shown in FIG. 5, the suppression system 80 includes the activator 84 and the distribution network 86, according to an exemplary embodiment. The suppression system 80 may be configured to provide a fire suppressant or agent (e.g., gas, liquid, gel, dry chemical, etc.) to components of the battery pack 20, for example in response to a failure or a runaway event of a component of the battery pack 20. The activator 84 may include a valve, seal, pump, sensor, and/or any other suitable component configured to selectively transfer a suppressant from the suppression system 80 to components of the battery pack 20 (e.g., via the distribution network 86). According to an exemplary embodiment, the distribution network 86 is coupled to the cooling channel 74, such that the suppression system 80 may provide a suppressant to the cooling channel 74 (e.g., via the distribution network 86) and/or components of the battery pack 20. In this regard, the system 10 of FIG. 5 may couple the suppression system 80 and the cooling system 70, such that the suppression system 80 utilizes existing components of the battery pack 20 (e.g., the cooling channel 74) to provide a suppressant to the battery pack 20. As shown in FIG. 5, the distribution network 86 and the cooling channel 74 may be coupled within the battery modules 40; however, in other embodiments the distribution network 86 and the cooling channel 74 are coupled at one or more other portions of the battery pack 20 (e.g., outside the battery module 40, within the subpack 30, the battery pack 20, etc.). In some embodiments, the distribution network 86 and the cooling channel 74 are coupled using one or more coupling components (e.g., a valve, switch, sensor, pressure seal, temperature seal, etc.), so as to selectively provide a suppressant to components of the battery pack 20.

Referring now to FIG. 6, the cooling channel 74 of the system 10 of FIG. 5 is shown in greater detail, according to an exemplary embodiment. The cooling channel 74 is shown to include one or more passageways 602, which may be configured to facilitate movement of a coolant and/or a suppressant to/from components of the battery pack 20. In an exemplary embodiment, the passageways 602 are substantially planar (e.g., one on top of the other) and include a suitable number of passageways 602 (e.g., 5, 10, 15, 20, etc.) configured to compliment the size of the battery cells 50 (e.g., height, width, etc.). The passageways 602 may extend along the length of the cooling channel 74, and may be arranged adjacent to (e.g., proximate, coupled to, in contact with, etc.) the battery cells 50, such that thermal energy generated by the battery cells 50 (e.g., when charging or discharging electrical energy) is transferred to the coolant within the passageways 602. In an exemplary embodiment, one or more passageways 602 is coupled to the distribution network 86 of the suppression system 80. In this regard, the passageways 602 may also be configured to facilitate movement of a suppressant (e.g., via the distribution network 86) to a component of the battery pack 20, for example in response to a failure or a runaway event.

Referring now to FIG. 7, the cooling channel 74 and the distribution network 86 of the system 10 of FIG. 5 are schematically shown in greater detail, according to an exemplary embodiment. In an exemplary embodiment, the distribution network 86 is coupled to the passageways 602 of the cooling channel 74 (as shown in FIG. 7), and the distribution network 86 is configured to provide a suppressant to the passageways 602. The distribution network 86 may be coupled to the passageways 602 (e.g., the cooling channel 74) within the battery module 40, and/or may be configured to provide the suppressant to the passageways 602 in order to deliver the suppressant to a target area. In an exemplary embodiment, the distribution network 86 is configured to provide the suppressant in an amount and/or pressure, such that the passageways 602 receive (e.g., are flooded by) the suppressant and expel existing coolant within the passageways 602. In some embodiments, the distribution network 86 is coupled to a number of active passageways 602 (e.g., coupled to the cooling system 70, the coolant source 72, etc.) and/or a number of inactive passageways 602 (e.g., de-coupled from the cooling system 70, the coolant source 72, etc.). In this regard, a number of active passageways 602 may receive (e.g., be flooded by) a suppressant and expel existing coolant within the passageways 602, and/or a number of inactive passageways 602 may receive the suppressant, in order to deliver the suppressant to a target area. In some embodiments, the distribution network 86 and the passageways 602 are coupled via a valve, switch, seal, and/or any other suitable coupling mechanism, which are configured to provide selective delivery of the suppressant to the passageways 602.

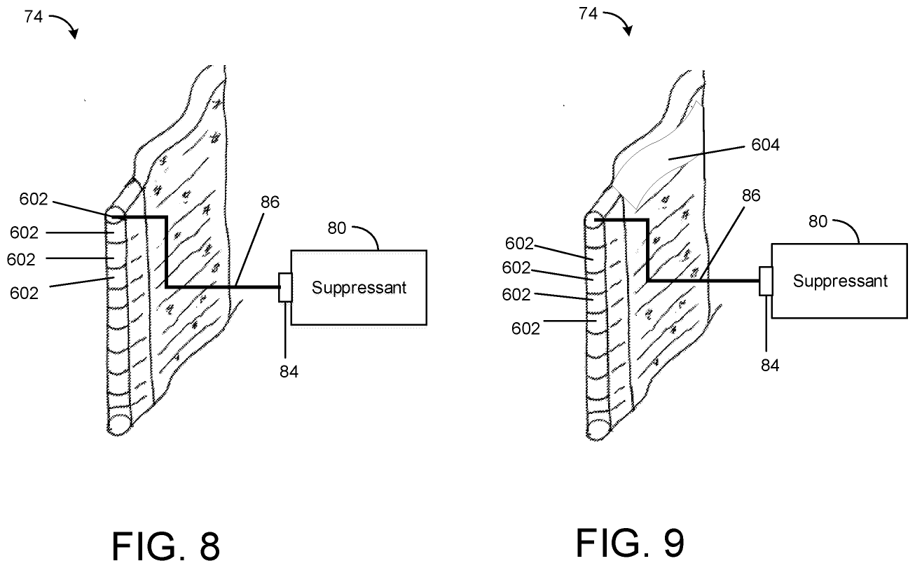

Referring now to FIG. 8, the cooling channel 74 and the distribution network 86 of the system 10 of FIG. 5 are shown in greater detail, according to another embodiment. As shown in FIG. 8, the distribution network 86 may be coupled to one passageway 602 of the cooling channel 74. In this regard, the cooling channel 74 may include one or more passageways 602 that are configured to receive a coolant (e.g., via the cooling system 70, the coolant source 72, etc.), and/or one or more passageways 602 that are configured to receive a suppressant (e.g., via the suppression system 80). In some embodiments, the one or more passageways 602 coupled to the distribution network 86 include an aperture, or plurality of apertures, along the passageway 602. The aperture (or plurality of apertures) may allow for delivery of a suppressant to a specified target area (e.g., at an aperture), or allow for uniform delivery of the suppressant along the passageway 602 via a plurality of apertures. In other embodiments, the distribution network 86 is coupled to any number of passageways 602 (e.g., two, three, etc.), via any suitable coupling feature (e.g., a valve, switch, seal, etc.), and/or at another suitable portion of the battery pack 20 (e.g., outside the battery module 40, within the subpacks 30, the battery pack 20, etc.).

Referring now to FIG. 9, the cooling channel 74 and the suppression system 80 of the system 10 of FIG. 5 are shown in greater detail, according to another embodiment. In an exemplary embodiment, the cooling channel 74 also includes a suppressant membrane 604, which is configured to selectively seal the cooling channel 74 (and/or the passageways 602). The suppressant membrane 604 is shown to couple an exterior of the cooling channel 74 (and/or the passageways 602) and extend the length of the cooling channel 74, and may be configured to selectively seal one or more apertures along one or more passageways 602. For example, the suppressant membrane 604 may be coupled to an exterior of a passageway 602 coupled to the distribution network 86 (e.g., a passageway 602 for delivery of a suppressant, as discussed in FIG. 8), such that the suppressant membrane 604 seals one or more apertures along the passageway 602. According to an exemplary embodiment, the suppressant membrane 604 is also configured to selectively unseal the passageway 602, for example in response to a failure and/or thermal runaway event. In this regard, the suppressant membrane 604 may seal one or more apertures of a passageway 602 (e.g., under standard operating conditions), and in response to a failure and/or thermal runaway event (e.g., a change in temperature, change in pressure, etc.), the suppressant membrane 604 may unseal one or more apertures of the passageway 602 so as to facilitate delivery of a suppressant to a target area or areas. According to an exemplary embodiment, the suppressant membrane 604 is formed of a temperature and/or pressure resistant plastic or polymer, which may be fit to the cooling channel 74; however, in other embodiments the suppressant membrane 604 is formed of another suitable material. In some embodiments, the suppressant membrane 604 is configured to couple all the passageways 602 of the cooling channel 74 (e.g., the entire cooling channel 74), and/or the suppressant membrane 604 is configured to seal the cooling channel 74 (e.g., passageways 602) so as to prevent coolant leakage or seep under certain operating conditions.

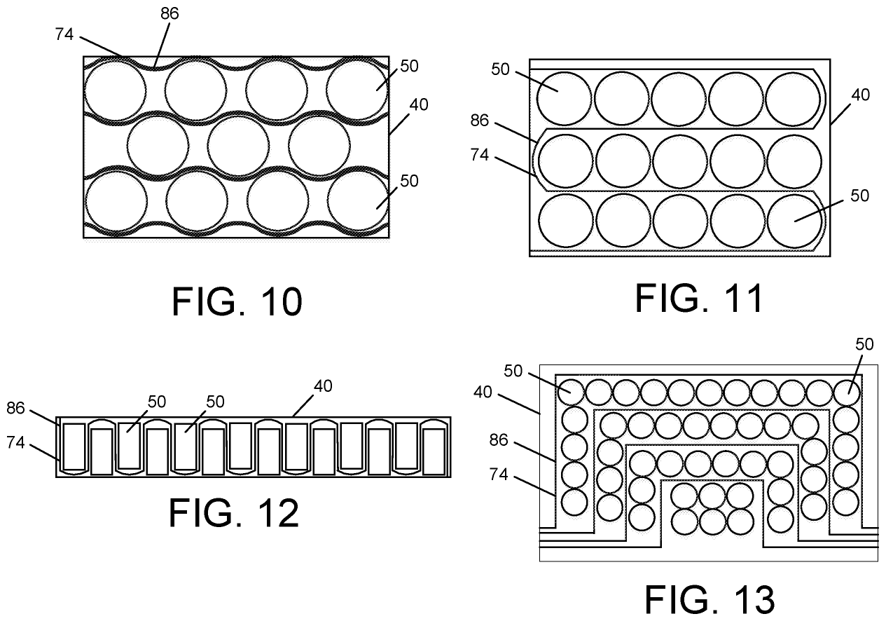

Referring generally to FIGS. 10-13, the cooling system 70 (e.g., the cooling channel 74) and the suppression system 80 (e.g., the distribution network 86) are shown, according to some embodiments. As discussed above, the cooling system 70 (e.g., the cooling channel 74, the passageways 602, etc.) and/or the suppression system 80 (e.g., the distribution network 86) may have various configurations relative to (e.g., within, around, etc.) the battery pack 20 and/or components thereof (e.g., the subpack 30, the battery module 40, the battery cells 50, etc.). According to an exemplary embodiment, the cooling channel 74 and/or the distribution network 86 are configured to have various configurations relative to (e.g., within, around, etc.) one or more battery cells 50 arranged within a battery module 40.

In some embodiments, the cooling channel 74 and/or the distribution network 86 extend along one or more axis in a non-linear pattern (e.g., as shown in at least FIG. 10). For example, the cooling channel 74 and/or the distribution network 86 may extend from a first side of the battery module 40 (e.g., a first side wall, a front wall, etc.) to a second side of the battery module 40 (e.g., a second side wall, a rear wall, etc.) in a wave-like pattern. In some embodiments, the cooling channel 74 and/or the distribution network 86 include a plurality of channels/networks, for example at a bottom, middle, and/or top of the battery cells 50. In other embodiments, the cooling channel 74 and/or the distribution network 86 extend along one or more axis in a linear pattern.

In other embodiments, the cooling channel 74 and/or the distribution network 86 extend in a serpentine pattern within the battery module 40. For example, the cooling channel 74 and/or the distribution network 86 may extend in a serpentine pattern from a first side of the battery module 40 (e.g., a first side wall, a front wall, etc.) to a second side of the battery module 40 (e.g., a second side wall, a rear wall, etc.) (e.g., as shown in at least FIG. 11). In other embodiments, the cooling channel 74 and/or the distribution network 86 extend in a serpentine pattern from a first side of the battery module 40 (e.g., a top wall, etc.) to a second side of the battery module 40 (e.g., a bottom wall, etc.) (e.g., as shown in at least FIG. 12). In an exemplary embodiment, the cooling channel 74 and/or the distribution network 86 extend in a serpentine pattern within the battery module 40 between one or more battery cells 50 (e.g., as shown in FIGS. 11-12). In other embodiments, the cooling channel 74 and/or the distribution network 86 include other serpentine shapes or configurations (e.g., angled, in a rectangular, square, etc. configuration).

In other embodiments, the cooling channel 74 and/or the distribution network 86 extend along the battery module 40 in a single direction. For example, the cooling channel 74 and/or the distribution network 86 may extend from a first side of the battery module 40 (e.g., a first side wall, a front wall, etc.) to a second side of the battery module 40 (e.g., a second side wall, a rear wall, etc.) in a substantially rectangular configuration (e.g., as shown in at least FIG. 13). In other embodiments, the cooling channel 74 and/or the distribution network 86 extend within the battery module 40 in another configuration (e.g., circular, oval, etc.). In yet other embodiments, the cooling channel 74 and/or the distribution network 86 extend along one or more portions of the battery module 40 (e.g., a top wall, a bottom wall, a middle portion, a bottom portion of one or more battery cells 50, a bottom portion of one or more battery cells 50, etc.).

It should be understood that while FIGS. 10-13 illustrate exemplary configurations of the cooling channel 74 and/or the distribution network 86 relative to the battery cells 50 and/or the battery module 40, in other exemplary embodiments the cooling channel 74 and/or the distribution network 86 are arranged in other configurations relative to one or more components of the battery pack 20. For example, the cooling channel 74 and/or the distribution network 86 may be arranged relative to a housing of the battery pack 20. In other embodiments, the cooling channel 74 and/or the distribution network 86 are arranged relative to one or more subpacks 30 of the battery pack 20. In yet other embodiments, the cooling channel 74 and/or the distribution network 86 are arranged relative to one or more battery modules 40 (e.g., within the subpack 30, etc.) of the battery pack 20.

As an illustrative example, the components of FIGS. 1-13 may be used to address, and/or mitigate a failure or a runaway event of the battery pack 20. According to an exemplary embodiment, the cooling system 70 is coupled to the suppression system 80, such that the suppression system 80 is integrated with components of the cooling system 70 (e.g., the cooling channel 74, etc.). For example, the distribution network 86 may be coupled to the passageways 602 of the cooling channel 74. In an exemplary embodiment, the distribution network 86 is coupled to the passageways 602 within the battery module 40; however, in other embodiments the distribution network 86 is coupled to the passageways 602 (or any suitable number thereof) at another portion of the battery pack 20 (e.g., outside the battery module 40 via a valve or switch, etc.). In operation, the cooling system 70 may be configured to provide a coolant to components of the battery pack 20 (e.g., via the passageways 602) in order to facilitate maintaining a consistent, low operating temperature of the battery pack 20. The distribution network 86 may be coupled (e.g., sealed coupling, a valve, switch, etc.) to the cooling channel 74, such that the suppressant and/or coolant remain unmixed when the cooling system 70 maintains an appropriate temperature. However, in some instances the cooling system 70 is unable to maintain a consistent and/or low operating temperature of the battery pack 20.

For example, in some circumstances components of the battery pack 20 may begin to operate at elevated current levels, temperatures, pressures, and/or other characteristics indicative of a failure or a thermal runaway event. In an exemplary embodiment, one or more sensors of the control system 100 identify a change in current, voltage, or charge level indicative of a fire (e.g., above a predetermined threshold, a deviation threshold, etc.). In some embodiments, a sensor of the control system 100 identifies the presence of a gas and/or smoke produced by a fire. In other embodiments, a sensor identifies a change in temperature and/or pressure (e.g., above a predetermined threshold, a deviation threshold, etc.) within one or more components of the battery pack 20 indicative of a fire or component failure (e.g., rupture, etc.). According to an exemplary embodiment, the controller 102 may activate the suppression system 80, for example to address (e.g., prevent or mitigate) the identified failure or thermal runaway event.

The suppression system 80 may include the activator 84 configured to transfer a suppressant from the suppression system 80 to the battery pack 20. For example, the activator 84 may impel (e.g., pump) the suppressant from the suppressant container 82, through the distribution network 86, and to the passageways 602. According to an exemplary embodiment, the passageways 602 are configured to facilitate targeted delivery of the suppressant to components of the battery pack 20. For example, the passageways 602 may receive (e.g., be flooded with) the suppressant, and facilitate delivery of the suppressant to the battery cell 50 and/or battery module 40 responsible for the identified failure or thermal runaway event (e.g., identified via the controller 102).

In some embodiments, the failure or runaway event causes a rupture in the passageway 602 (and/or the cooling channel 74), such that the suppressant is delivered to the target area via the rupture in the passageway 602. In other embodiments, the suppression system 80 (e.g., activator 84) is configured to pressurize the passageway 602, such that the passageway 602 ruptures at the target area (e.g., via temperature, pressure, etc. levels) and/or delivers the suppressant to the target area via the targeted rupture. In some embodiments, the distribution network 86 is coupled to the passageway 602, and the passageway 602 is configured to deliver the suppressant to one or more components of the battery pack 20, for example to fill and/or deliver the suppressant to the battery pack 20 (e.g., a battery cell 50, an internal portion of the battery module 40, an external surface of the battery module 40, an internal portion of the subpack 30, an external surface of the subpack 30, etc.). In this regard, in some embodiments the distribution network 86 (e.g., via the passageway 602, etc.) is configured to flood (e.g., fill, etc.) one or more components of the battery pack 20 (e.g., the subpack 30, the battery module 40, etc.) to cool the battery pack 20 (e.g., provide suppressant to an increased number of surfaces of the battery pack 20), dilute one or more flammable materials or gasses within or escaping the battery pack 20, and/or mitigate or eliminate a flame or fire within the battery pack 20 (e.g., the batter module 40, the subpack 30, the housing, etc.).

In other embodiments, the distribution network 86 is coupled to one or more passageways 602 (e.g., one passageway, an inactive passageway, etc.), and the suppressant is delivered to the target site (e.g., directly, uniformly, etc.) via one or more apertures in the passageway 602. In yet other embodiments, the cooling channel 74 (e.g., passageways 602) includes the suppressant membrane 604 coupled to an exterior of the cooling channel 74 (e.g., passageways 602), the suppressant membrane 604 configured to selectively seal one or more apertures along a passageway 602. In response to the failure or thermal runaway event, the suppressant membrane 604 may be configured to unseal the one or more apertures, thereby facilitating delivery of the suppressant to a target site (e.g., localized area based on temperature change) and/or target sites (e.g., uniform area based on pressure change). In this regard, the cooling system 70 and/or the suppression system 80 may incorporate various components and/or configurations described herein in order to prevent, address, and/or otherwise mitigate a failure or a runaway event of the battery pack 20.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

1. A battery system, comprising:
a housing defining a volume;
a battery module arranged within the housing, wherein the battery module comprises a plurality of battery cells configured to provide an electrical output;
a cooling system having a cooling channel, the cooling channel configured to pass within the battery module and arranged adjacent the plurality of battery cells, wherein the cooling channel is configured to facilitate temperature control of the battery module; and
a suppression system having a suppressant, wherein the suppression system is configured to provide the suppressant to the battery module to mitigate a thermal runaway event.

2. The battery system of claim 1, wherein the suppression system includes a distribution network coupled to one or more passages of the cooling channel, and wherein in response to a failure at the battery module the suppression system is configured to provide the suppressant to the one or more passages.

3. The battery system of claim 2, wherein the one or more passages are configured to facilitate movement of the suppressant to a target area adjacent to a rupture of the one or more passages.

4. The battery system of claim 2, wherein the suppression system is configured to provide the suppressant to the one or more passages at a pressure, wherein the pressure of the suppressant in the one or more passages is such that the one or more passages is configured to rupture at a target area and deliver the suppressant to the target area.

5. The battery system of claim 2, wherein the failure at the battery module includes a change in operating temperature of a battery cell positioned adjacent to the one or more passages above a threshold, wherein the change in operating temperature of the battery cell above the threshold is such that the one or more passages is configured to rupture at a target area and deliver the suppressant to the target area.

6. The battery system of claim 2, wherein the cooling channel includes a suppressant membrane coupled to an exterior of the cooling channel, the suppressant membrane configured to selectively seal an aperture of the one or more passages of the cooling channel.

7. The battery system of claim 6, wherein the failure at the battery module includes a change in operating temperature of a battery cell positioned adjacent to the one or more passages above a threshold, and the failure at the battery module causes the suppressant membrane to unseal the aperture of the one or more passages and facilitate delivery of the suppressant to a target area.

8. The battery system of claim 2, wherein the distribution network is coupled with a first passage of the one or more passages of the cooling channel and a second passage of the one or more passages of the cooling channel, wherein the first passage is configured to receive a coolant to facilitate temperature control of the battery system and the second passage is configured to facilitate movement of the suppressant to a target area in response to the failure at the battery module.

9. The battery system of claim 2, wherein the cooling system further comprises another cooling channel, the other cooling channel configured to pass along an exterior of the battery module, wherein the distribution network is coupled to the one or more passages of the other cooling channel, and wherein in response to the failure at the battery module the suppression system is configured to provide the suppressant to the one or more passages of the other cooling channel.

10. A vehicle comprising:
a chassis;
a plurality of tractive elements coupled with the chassis;
a prime mover coupled with the plurality of tractive elements, the prime mover configured to drive the plurality of tractive elements to propel the vehicle; and
a battery system coupled with the chassis, the battery system comprising:
a housing defining a volume;
a battery module arranged within the housing, wherein the battery module comprises a plurality of battery cells configured to provide an electrical output;
a cooling system having a cooling channel, the cooling channel configured to pass within the battery module and arranged adjacent the plurality of battery cells, wherein the cooling channel is configured to facilitate temperature control of the battery module; and
a suppression system having a suppressant, wherein the suppression system is configured to provide the suppressant to the battery module to mitigate a thermal runaway event.

11. The vehicle of claim 10, wherein the suppression system includes a distribution network coupled to one or more passages of the cooling channel, and wherein in response to a failure at the battery module the suppression system is configured to provide the suppressant to the one or more passages.

12. The vehicle of claim 11, wherein the one or more passages are configured to facilitate movement of the suppressant to a target area adjacent to a rupture of the one or more passages.

13. The vehicle of claim 11, wherein the suppression system is configured to provide the suppressant to the one or more passages at a pressure, wherein the pressure of the suppressant in the one or more passages is such that the one or more passages is configured to rupture at a target area and deliver the suppressant to the target area.

14. The vehicle of claim 11, wherein the failure at the battery module includes a change in operating temperature of a battery cell positioned adjacent to the one or more passages above a threshold, wherein the change in operating temperature of the battery cell above the threshold is such that the one or more passages is configured to rupture at a target area and deliver the suppressant to the target area.

15. The vehicle of claim 11, wherein the cooling channel includes a suppressant membrane coupled to an exterior of the cooling channel, the suppressant membrane configured to selectively seal an aperture of the one or more passages of the cooling channel.

16. (canceled)

17. A battery pack, comprising
a housing defining a volume;
a battery module arranged within the housing, wherein the battery module comprises a plurality of battery cells configured to provide an electrical output;
a cooling channel configured to pass within the battery module and arranged adjacent the plurality of battery cells, wherein the cooling channel is configured to facilitate temperature control of the battery module; and
a distribution network coupled to one or more passages of the cooling channel, the distribution network is configured to receive a suppressant to mitigate a thermal runaway event.

18. (canceled)

19. The battery pack of claim 17, wherein the one or more passages are configured receive the suppressant at a pressure, and wherein the pressure of the suppressant in the one or more passages is such that the one or more passages is configured to rupture at a target area and deliver the suppressant to the target area.

20. The battery pack of claim 19, wherein the cooling channel includes a suppressant membrane coupled to an exterior of the cooling channel, the suppressant membrane configured to selectively seal an aperture of the one or more passages of the cooling channel.

21-24. (canceled)

25. The battery pack of claim 1, comprising:
a plurality of subpacks arranged within the housing, wherein the battery module is of a plurality of battery modules, each of the plurality of subpacks comprising a respective battery module of the plurality of battery modules;
wherein the cooling channel is adjacent at least one subpack of the plurality of subpacks.

26. (canceled)

27. The battery pack of claim 25, wherein the one or more passages are configured receive the suppressant at a pressure, and wherein the pressure of the suppressant in the one or more passages is such that the one or more passages is configured to rupture at a target area and deliver the suppressant to the target area.

28. (canceled)
